(19) United States
(12) Patent Application Publication
(10) Pub. No.: US 2019/0221128 A1
(43) Pub. Date: Jul. 18, 2019

(54) FLIGHT CONTROL METHOD, DEVICE, AND SMART TERMINAL

(71) Applicant: SZ DJI TECHNOLOGY CO., LTD., Shenzhen (CN)

(72) Inventors: Zhuo GUO, Shenzhen (CN); Zhuo XIE, Shenzhen (CN); Zebo YANG, Shenzhen (CN); Wenlin LI, Shenzhen (CN); Lei WANG, Shenzhen (CN); Ding WANG, Shenzhen (CN); Haoyu LI, Shenzhen (CN)

(21) Appl. No.: 16/361,659

(22) Filed: Mar. 22, 2019

Related U.S. Application Data
(63) Continuation of application No. PCT/CN2016/099769, filed on Sep. 22, 2016.

(51) Int. Cl. G08G 5/04; G08G 5/00; B64C 39/02; G05D 1/00

(52) U.S. Cl. CPC G08G 5/045; G08G 5/0039; B64C 2201/146; B64C 39/024; G05D 1/0016; G08G 5/0013

(57) ABSTRACT

A flight control method includes acquiring, by a smart terminal, data of at least two flight routes. The flight control method also includes associating, by the smart terminal and based on preset information of at least two aircrafts, at least one aircraft with a flight route of the at least two flight routes. The flight control method further includes based on a result of the associating, sending, by the smart terminal, data of the flight route to the associated at least one aircraft.

### CROSS-REFERENCE TO RELATED APPLICATION

This application is a continuation application of International Application No. PCT/CN2016/099769, filed on Sep. 22, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of aircrafts and, more particularly, to a control method, device, and smart terminal for controlling aircrafts.

### BACKGROUND

An Unmanned Aerial Vehicle (UAV) is an aircraft whose flight operation can be controlled by a remote control device and an on-board programmable control device. A UAV does not need a pilot to operate the aircraft in a cockpit. The entire flight of the UAV can be accomplished under control of electronic devices. Therefore, the UAVs are widely used in surveillance, disaster rescue, observation of wild animals, mapping, news report, and power line inspections, etc.

In conventional technologies for controlling the UAVs, a user can control only a single UAV through a remote control device. The efficiency of controlling the UAVs is therefore low.

### SUMMARY

In accordance with the present disclosure, there is provided a flight control method. The flight control method includes acquiring, by a smart terminal, data of at least two flight routes. The flight control method also includes associating, by the smart terminal and based on preset information of at least two aircrafts, at least one aircraft with a flight route of the at least two flight routes. The flight control method further includes based on a result of the associating, sending, by the smart terminal, data of the flight route to the associated at least one aircraft.

Also in accordance with the present disclosure, there is provided a smart terminal. The smart terminal includes a user interface and a processor. The user interface is configured to process data relating to human-machine interaction. The processor is configured to acquire data of at least two flight routes. The processor is also configured to associate, based on preset information of at least two aircrafts, at least one aircraft with a flight route of the at least two flight routes. The processor is further configured to send, based on a result of the associating, data of the flight route to the associated at least one aircraft.

In various embodiments of the present disclosure, depending on applications, data of different flight routes may be sent to different aircrafts. The data of different flight routes may be obtained as a result of division of data of a main flight route. In some embodiments, the data of different flight routes may contain data of independent flight routes. Embodiments of the present disclosure allow for control of multiple aircrafts using a single remote control device, thereby enhancing the efficient of flight control, and satisfying user demands for automatic and intelligent control of multiple aircrafts.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of a flight control system according to an example embodiment.

FIG. 2 is a schematic diagram of a flight control system according to another example embodiment.

FIG. 3 is a schematic diagram of a flight control system according to another example embodiment.

FIG. 4 is a flow chart illustrating a flight control method according to an example embodiment.

FIG. 5 is a flow chart illustrating a flight control method according to another example embodiment.

FIG. 6 is a schematic diagram of a flight control device according to another example embodiment.

FIG. 7 is a schematic diagram of a smart terminal according to another example embodiment.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

According to various embodiments of the present disclosure, a smart terminal can control multiple aircrafts separately and independently, or can control multiple aircrafts simultaneously. The smart terminal can send flight instructions or data of flight routes to multiple aircrafts to execute flight tasks. The smart terminal can be any device that is equipped with wireless or wired communication capability, such as a personal computer (a desktop or a laptop), a smart phone, a tablet, etc. When the smart terminal acquires data of multiple flight routes, the smart terminal can associate, link, or assign at least one aircraft with or to each of the multiple flight routes. The smart terminal can send the data of each flight route to the associated one or more aircrafts either simultaneously or sequentially when there are multiple aircrafts associated with the flight route, thereby realizing simultaneous control of the flight of multiple aircrafts.

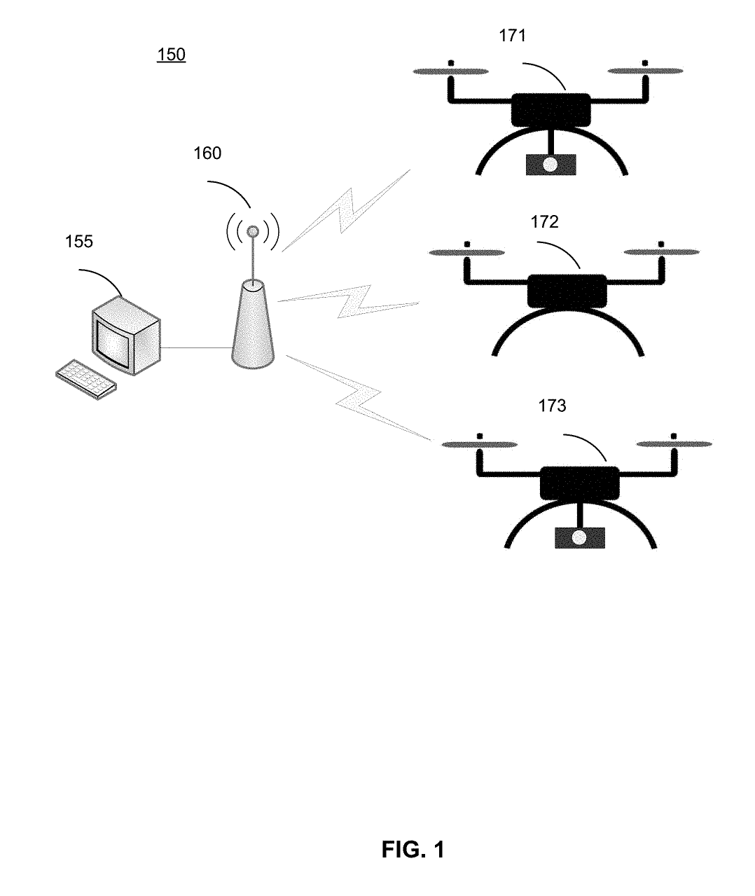

FIG. 1 is a schematic diagram of a flight control system 150 according to an embodiment of the present disclosure. The flight control system 150 includes a smart terminal 155, a broadcasting device 160, and one or more aircrafts 171, 172, and 173. The smart terminal 155 may control the one or more aircrafts 171, 172, and 173 through the broadcasting device 160. When sending data of flight routes to the one or more aircrafts 171, 172, and 173, the smart terminal 155 may connect to the broadcasting device 160 through a data port, such as a USB port. The smart terminal 155 may send data of the flight routes to the corresponding aircraft(s) through the broadcasting device 160. For example, the smart terminal 155 may package data of a flight route and an identification of the associated aircraft (or identifications of the associated aircrafts) into a single broadcasting message, which may be broadcasted by the broadcasting device 160. When the aircraft (e.g., aircraft 171, 172, or 173) receives the broadcasting message, the aircraft may compare the identification included in the broadcasting message with an identification of the aircraft. When the identification included in the broadcasting message is the same as the identification of the aircraft, the aircraft may retrieve the data of the flight route from the broadcasting message, and execute the data of the flight route. When the identification included in the broadcasting message is not the same as the identification of the aircraft, the aircraft may ignore or discard the broadcasting message.

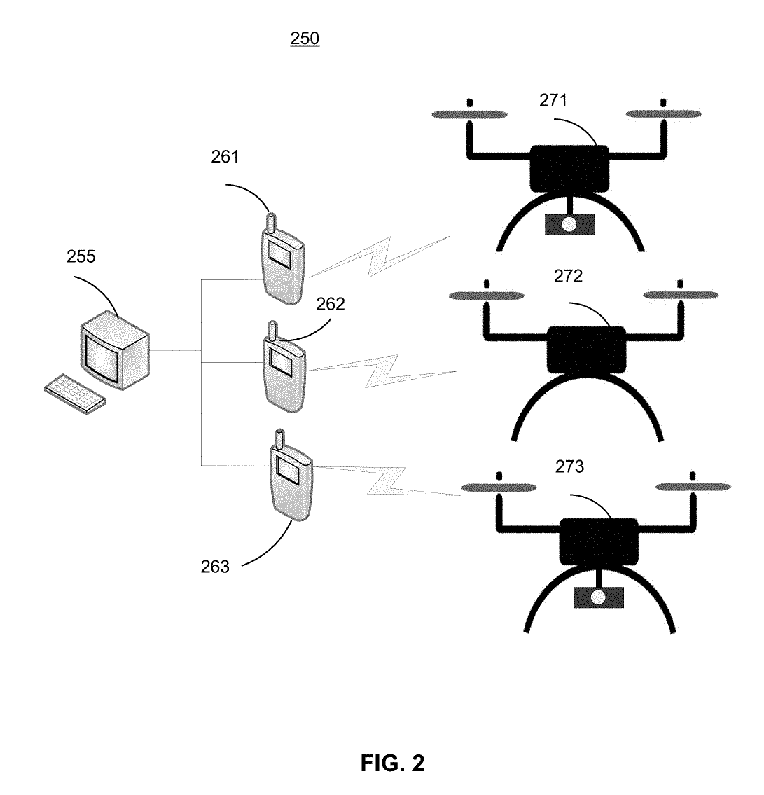

FIG. 2 is a schematic diagram of a flight control system 250 according to another embodiment of the present disclosure. The flight control system 250 includes a smart terminal 255, one or more remote control devices 261, 262, and 263, and one or more aircrafts 271, 272, and 273. Each remote control device 261, 262, or 263 may be configured to control an aircraft 271, 272, or 273. The smart terminal 255 may be coupled with the one or more remote control devices 271, 272, and 273 through wireless communication or wired communication using, for example, USB data ports. The smart terminal 255 may send data of a flight route to each remote control device 261, 262, or 263 through the wired or wireless communication. The one or more remote control device 261, 262, or 263 may send the data of the flight route to one or more aircrafts that are associated with the remote control device. The smart terminal 255 may associate data of each flight route with one or more aircrafts, and send the data of each flight route to one or more corresponding remote control devices, which then send the data of the flight route to the one or more associated aircrafts.

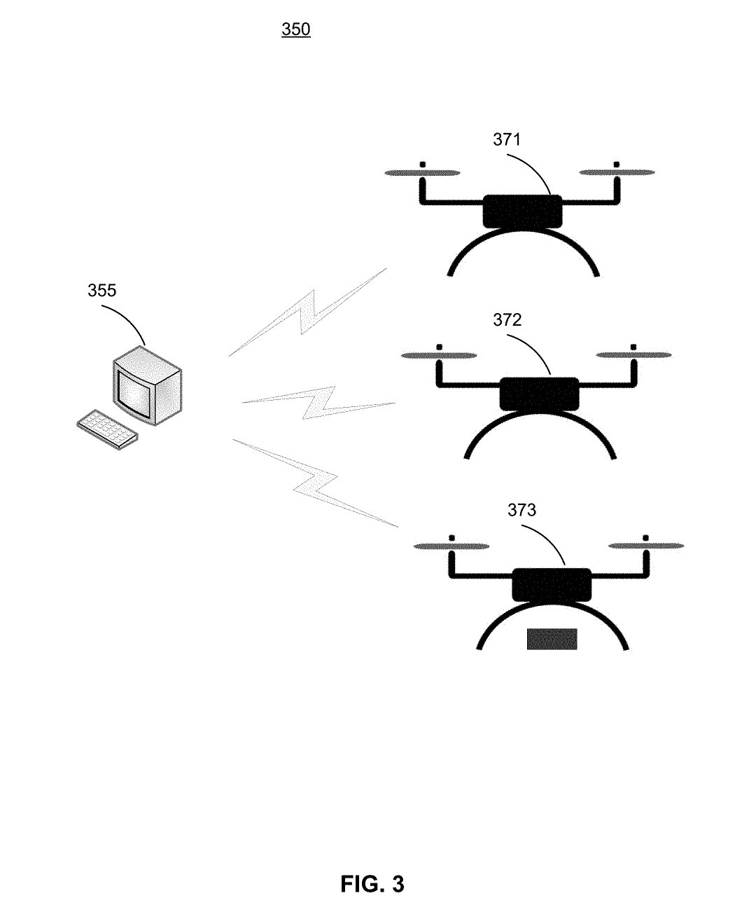

FIG. 3 is a schematic diagram of a flight control system 350 according to another embodiment of the present disclosure. The flight control system 350 includes a smart terminal 355 and one or more aircrafts 371, 372, and 373. The smart terminal 355 communicates with the aircrafts 371, 372, and 373 through wireless communication. For example, the smart terminal 355 may include a WiFi communication device for the wireless communication. Aircrafts 371, 372, and 373 may be wirelessly connected to the WiFi communication device to transmit and/or receive data from the smart terminal 355. For example, aircrafts 371, 372, and 373 may receive the data of the flight route, as well as other commands or signals, from the smart terminal 355.

When the smart terminal 355 controls the flight of multiple aircrafts substantially simultaneously, the flight routes represented by the data of the flight routes executed by the aircrafts may have one or more crossing points. At a crossing point, different aircrafts may collide with one another. A crossing point refers to two or more location points on two or more flight routes that are represented by respective data, where a distance between the two or more location points is smaller than a predetermined distance. The aircrafts that separately execute the data of the two or more flight routes may arrive at the two or more location points at substantially the same time or within a short time window around a specific time. The two or more location points are referred to as a crossing point, or point of collision. When the smart terminal 355 detects the existence of a point of collision, the smart terminal 355 may adjust the data of the two or more flight routes that have a crossing point, such that collision at the crossing point is avoided or the probability of collision is reduced when the aircrafts execute the data of the flight routes.

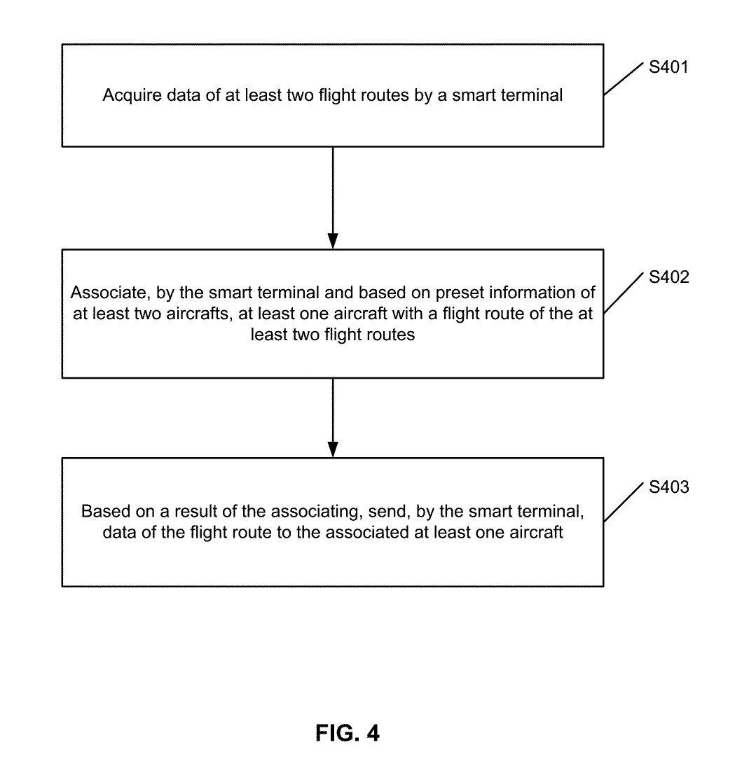

FIG. 4 is a flow chart illustrating a flight control method according to an embodiment of the present disclosure. The method shown in FIG. 4 may be implemented by any smart terminal disclosed herein. For example, the smart terminals may include personal computers (desktops, laptops), smart phones, and smart wearable devices, which may be equipped with communication devices for wireless and/or wired communication. The method shown in FIG. 4 includes steps of S401-S403.

In step S401, the smart terminal acquires data of at least two flight routes. In some embodiments, the data of the at least two flight routes may include data of two or more flight routes obtained based on a user input on the smart terminal editing distribution of location points on the flight routes. The smart terminal may include a touch screen to display a control user interface. Through the control user interface, the user may specify points on a map displayed in the control user interface. Each point may be a location point for a flight route. Connecting the points may form part of or a complete flight route. In some embodiments, the data of the flight route include coordinates of the points on the map. In some embodiments, data of the at least two flight routes may be received by the smart terminal from one or more other smart terminals. For example, one or more other smart terminals may generate one or more flight routes based on input received from a user through a touch screen editing a map or a main flight route. The one or more other smart terminals may send data of the one or more flight routes to the smart terminal, which may be a smart phone, a wearable smart device, etc.

In step S402, the smart terminal may associate, based on preset information of at least two aircrafts, at least one aircraft with a flight route of the at least two flight routes. The flight route may be each flight route of the at least two flight routes. In some embodiments, information relating to the at least one aircraft that has established a connection with the smart terminal may be recorded or stored in the smart terminal. In some embodiments, information relating to an aircraft that has registered in the smart terminal may be recorded or stored in the smart terminal. Information relating to the at least two aircrafts may include at least one of: an identification of each aircraft, a communication identification of each remote control device associated with each aircraft, or a communication identification of each wireless communication device provided in each aircraft, etc. Information relating to the aircrafts may be used to distinguish different aircrafts. Information relating to the aircrafts may also be used to establish a communication between each aircraft and the smart terminal.

In some embodiments, the smart terminal may display a control user interface to a user on a display screen of the smart terminal. Through the control user interface, the user may select, link, associate, or assign one or more aircrafts for or to a flight route, such that the flight route is associated with the one or more aircrafts. The smart terminal may receive a user input associated with the selection or assignment. In some embodiments, the smart terminal may automatically select one or more aircrafts for a flight route, or automatically associate one or more aircrafts with a flight route. In some embodiments, functions provided by different aircrafts may be different. Thus, functions of the aircrafts registered in the smart terminal may also be different. For example, some aircrafts may be capable of executing a relatively long flight route. However, the imaging quality of the imaging device carried by the aircrafts, such as the camera, may be relatively low. Some other aircrafts may have better imaging devices that can provide images and/or videos of better quality. Based on advantages of different aircrafts and different demands on each flight route, the smart terminal may automatically select, link, associate, or assign an aircraft for or to a flight route in an intelligent manner. As a result, flight tasks associated with the data of the flight route may be better executed by the associated aircrafts.

After associating at least one aircraft with a flight route, the smart terminal may record or store a relationship between data of the flight route executed by the aircraft and information relating to the aircraft in a mapping table. For example, the mapping table may map an identification of the data of the flight route stored in a storage device with an identification of the aircraft.

In step S403, based on a result of the associating, the smart terminal may send data of the flight route to the associated at least one aircraft. For example, the smart terminal may send data of the at least two flight routes to any broadcasting device disclosed herein to trigger the broadcasting device to broadcast the data of at least two flight routes to at least two aircrafts. In some embodiments, the broadcasting device may be an independent device for broadcasting data of the flight route. That is, in some embodiments, the broadcasting device may not be part of the smart terminal, although in other embodiments, the broadcasting device may be part of the smart terminal. Each message or signal broadcasted by the broadcasting device may include data of a flight route and/or an identification of an aircraft that is associated with the flight route. An aircraft may receive the message or signal broadcasted by the broadcasting device, and may compare the identification of the aircraft included in the message with an identification of the aircraft itself. If the identifications match with one another, the aircraft may retrieve and execute the data of the flight route included in the message broadcasted by the broadcasting device.

In some embodiments, in step S403, sending the data of the flight route (e.g., each flight route of the at least two flight routes) to the associated at least one aircraft may include: determining, by the smart terminal, a remote control device corresponding to each aircraft, and sending the data of the flight route (e.g., each flight route) associated with the aircraft to the corresponding remote control device, to enable the remote control device to control the flight of the aircraft based on the data of the flight route associated with the aircraft. In other words, the mapping table may store an association relationship between data of the flight route and an identification of the remote control device corresponding to an aircraft. In some embodiments, when the smart terminal sends data of a flight route, the smart terminal may retrieve the identification of the remote control device that is associated with the data of the flight route, such as the hardware address of the remote control device. The smart terminal may send the data of the flight route based on the identification of the remote control device. In some embodiments, the smart terminal may send data of flight routes to multiple remote control devices. The smart terminal may control the flight task or operation of an aircraft through a corresponding remote control device.

In some embodiments, in step S403, sending the data of the flight route (e.g., each flight route of the at least two flight routes) to the associated at least one aircraft may include: sending the data of the flight route to a flight control device provided in an aircraft associated with the flight route to enable the flight control device to control the flight of the aircraft based on the data of the flight route. In some embodiments, the mapping table may store an association relationship between data of the flight route and an identification of a communication device of the aircraft. When the smart terminal sends data of a flight route, the smart terminal retrieves the identification of the communication device corresponding to the data of the flight route, such as a Bluetooth identification of the communication device or a WiFi address of the communication device. The smart terminal may send the data of the flight route to the aircraft based on the identification of the communication device, such that the smart terminal may control flight tasks or operations of the aircraft.

In some embodiments, before sending the data of the flight route, the smart terminal may determine whether the data of the flight route can be split. For example, when the smart terminal determines that the data of the at least two flight routes include data of a flight route that satisfy predetermined criteria for splitting, the smart terminal may split or divide the data of the flight route that satisfy the predetermined criteria to generate data for a plurality of sub-routes. The smart terminal may send data of the sub-routes to at least one aircraft. The data of a flight route that satisfy the predetermined criteria may include data of the flight route that indicate that the length of the flight route is greater than a predetermined length. In some embodiments, the data of the flight route that satisfy the predetermined criteria include data of a flight route on which the number of location points on the flight route is greater than a predetermined number. In some embodiments, the data of the flight route that satisfy the predetermined criteria include data indicating that a remaining electrical power capacity of an aircraft associated with the data of the flight route is lower than a predetermined electrical power capacity that is needed to complete the flight tasks associated with the flight route.

According to various embodiments of the present disclosure, the smart terminal can send data of one or more flight routes to multiple aircrafts to execute. The data of the one or more flight routes may include data of multiple flight routes that are obtained by dividing or splitting data of a main flight route. Alternatively or additionally, the data of the one or more flight routes may include data of multiple independent flight routes. Embodiments of the present disclosure realize one-to-multiple control of the aircrafts. That is, a single smart terminal of the present disclosure can control flight of multiple aircrafts. As a result, efficiency of flight control of aircrafts is enhanced, and user demands for automatic and intelligent control of multiple aircrafts are also satisfied.

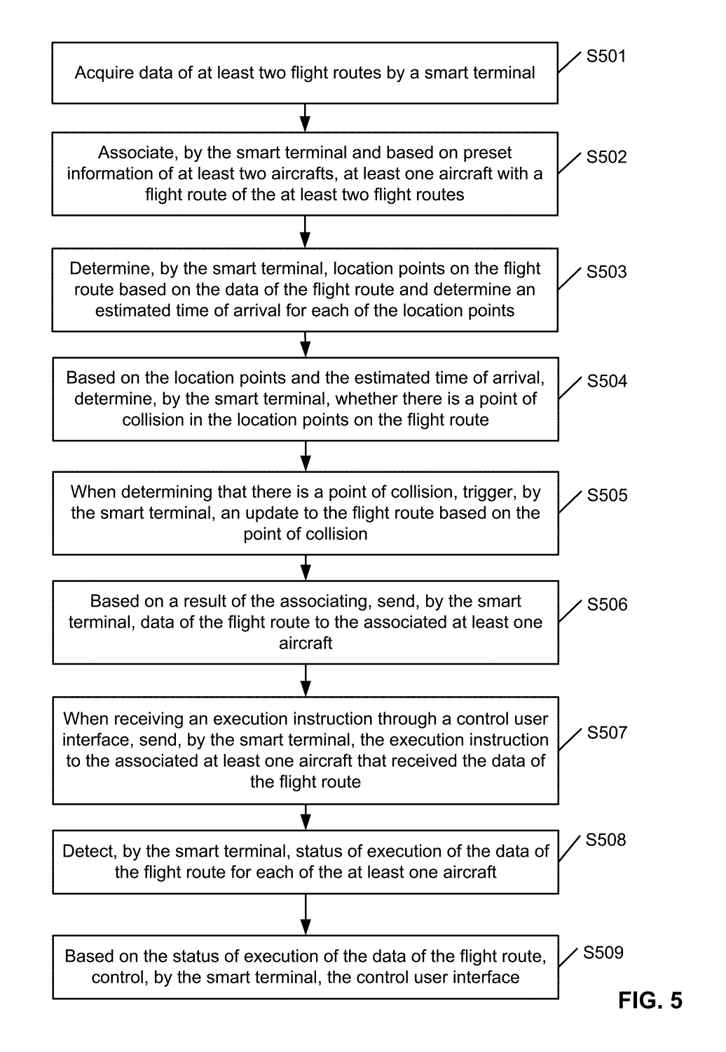

FIG. 5 is a flow chart illustrating a flight control method according to another example embodiment. The flight control method may be implemented by any smart terminal disclosed herein that is equipped with wireless or wired communication capability, such as a personal computer (e.g., a desktop, a laptop), a smart phone, or a smart wearable device, etc. The method includes the following steps.

In step S501, a smart terminal acquires data of at least two flight routes.

In step S502, the smart terminal associates, based on preset information of at least two aircrafts, at least one aircraft with a flight route (e.g., each flight route) of the at least two flight routes.

In step S503, the smart terminal determines location points on the flight route based on the data of the flight route and determines an estimated time of arrival for each of the location points. In some embodiments, determining the estimated time of arrival for each of the location points may include, based on a preset velocity of the at least one aircraft and each of the location points, calculating the estimated time of arrival for each of the at least one aircraft to arrive at each of the location points.

In step S504, based on the location points and the estimated time of arrival, the smart terminal determines whether there is a point of collision in the location points on the flight route. The point of collision refers to two corresponding location points on two or more flight routes that are represented by the data of the at least two flight routes, where a distance between the two or more corresponding location points is smaller than a predetermined distance. When two or more aircrafts execute the data of the two or more flight routes, the two or more aircrafts may arrive at the two or more corresponding location points at about the same time (e.g., simultaneously) or within a predetermined time window.

In step S505, when the smart terminal determines that there is a point of collision, the smart terminal may trigger an update to the flight routes based on the point of collision. In some embodiments, updating the flight routes may include editing coordinates of the point of collision, such that the distance between two or more corresponding locations points is greater than or equal to the predetermined distance.

When the smart terminal determines that there is no point of collision, or when the smart terminal completes updating the flight routes based on the point of collision, the smart terminal may perform step S506.

In step S506, based on a result of associating at least one aircraft with a flight route, the smart terminal may send data of the flight route to the associated at least one aircraft.

In some embodiments, steps S503-S505 may be performed by the smart terminal at time instances between two steps S506 when step S506 is repeatedly performed to send data of the flight route to a plurality of aircrafts.

In some embodiments, the steps S503-S505 are verification steps. For example, when multiple aircrafts receive data of multiple flight routes, the smart terminal may perform a safety verification for the multiple flight routes associated with the multiple aircrafts to ensure there is no crossing point on a same altitude. When the smart terminal determines that there is a crossing point, the smart terminal may presume that the flight routes may be executed at the same time by the multiple aircrafts. The smart terminal may then determine the location of each aircraft in the sky based on estimated velocity and time (e.g., time of arrival), thereby estimating the probability for multiple aircrafts to arrive at the same location simultaneously. When the smart terminal determines that there exist overlapping or close points in time and location in different flight routes, the smart terminal may send an alert message to a user who operates aircrafts executing the data of the flight routes, such that the user may adjust the potential crossing point (or point of collision) on the flight routes. If the flight routes are not executed at the same time, users may set a starting time for executing each flight route. The smart terminal may verify the safety of the flight route based on the starting time. The detailed verification process is the same as the above-described verification process.

In step S507, when receiving an execution instruction through a control user interface, the smart terminal sends the execution instruction to the associated at least one aircraft that received the data of the flight route, the execution instruction triggering the associated at least one aircraft to execute the data of the flight route.

In step S508, the smart terminal detects the status of execution of the data of the flight route for each of the at least one aircraft.

In step S509, based on the status of execution of the data of the flight route, the smart terminal controls the control user interface.

In some embodiments, when a user sends, e.g., through the smart terminal, data of one or more flight routes to one or more aircrafts, the user may select multiple aircrafts to execute the data of the one or more flight routes. If all of the selected multiple aircrafts have started executing the data of the one or more flight routes successfully, the multiple aircrafts may take off simultaneously and fly according to the one or more flight routes. Because different flight control systems may have different response time, or because when the smart terminal sends flight route execution instructions the communication may be interrupted, failure may occur in sending an execution instruction for executing the data of a specific flight route. When failure occurs in sending the execution instruction, the smart terminal may allow or disallow operations of a user relating to the flight route based on whether all of the selected aircrafts for executing the data of the flight route are still in the same status of executing the data of the flight route.

In some embodiments, in step S509, when the smart terminal determines, based on the status of execution of the data of the flight route, that an aircraft has not executed the data of the flight route, the smart terminal may display a first message on the control user interface, the first message indicating that the execution instruction cannot be received. The smart terminal may acquire an identification of the aircraft that has not executed the data of the flight route. The smart terminal may display a second message on the control user interface, the second message indicating that the control user interface is standing by to receive the execution instruction. When receiving the execution instruction through the control user interface after displaying the second message, the smart terminal may send the execution instruction to the aircraft identified by the identification that has not executed the data of the flight route. In some embodiments, when part of the data of the flight route has not been executed, the smart terminal may disable a start button displayed on the control user interface by, for example, changing a display style or color of the button (e.g., display the start button in gray). Disabling the start button may be an example of the first message. The smart terminal may also remove the selection of an aircraft that has already started executing the data of the flight route, and enable a flight route start button (e.g., by changing the gray color to a normal color of the flight route start button). Enabling the flight route start button may be an example of the second message. After the flight route start button is enabled, the user may send (e.g., through the smart terminal) the execution instruction for executing data of a flight route to an aircraft.

In some embodiments, in step S509, when the smart terminal determines, based on the status of execution of the data of the flight route, that an aircraft has not executed the data of the flight route, the smart terminal may display a third message on the control user interface, the third message indicating that a flight control instruction cannot be received. The smart terminal may acquire an identification of an aircraft that has already executed the data of the flight route. The smart terminal may display, on the control user interface, a fourth message, the fourth message indicating that the control user interface is standing by to receive the flight control instruction. When the control user interface receives the flight control instruction, the smart terminal may send the flight control instruction to the aircraft identified by the identification that has already executed the data of the flight route. In some embodiments, when at least part of the data of the flight route has not been executed, the smart terminal may disable the suspend and stop button by changing the display of the style and/or color of the suspend and stop button (such as by displaying the suspend and stop button in gray). Changing the display of the style and/or color of the suspend and stop button may be an example of the third message. The smart terminal may remove the selection of an aircraft that has not executed the data of the flight route, and may then enable the suspend and stop button (e.g., by changing the gray color to a normal color of the suspend and stop button). Enabling the suspend and stop button may be an example of the fourth message. After the suspend and stop button is enabled, a user may send, e.g., through the control user interface of the smart terminal, a suspend and stop instruction or signal to an aircraft that has already started executing the data of the flight route.

In some embodiments, in step S509, when the smart terminal determines, based on the status of execution of the data of the flight route, that an aircraft has not taken off, the smart terminal may display a fifth message on the control user interface, the fifth message indicating that a take-off instruction cannot be received. The smart terminal may acquire an identification of the aircraft that has not taken off. The smart terminal may display a sixth message on the control user interface, the sixth message indicating that the control user interface is standing by to receive the take-off instruction. When the control user interface receives the take-off instruction, the smart terminal may send the take-off instruction to the aircraft identified by the identification that has not taken off. In some embodiments, when at least one aircraft has not taken off, the smart terminal may disable the start flight button on the control user interface by changing the display style and/or color of the start flight button, such as by displaying the start flight button in gray. Disabling the start flight button may be an example of the fifth message. The smart terminal may remove the selection of an aircraft that has already taken off. The smart terminal may then enable the start flight button, e.g., by changing the gray color to a normal color of the start flight button. Enabling the start flight button may be an example of the sixth message. After the start flight button is enabled, a user may control, e.g., through the control user interface of the smart terminal, the aircraft that has not been taken off to take off.

In some embodiments, in step S509, when the smart terminal determines, based on the status of execution of the data of the flight route, that an aircraft has not taken off, the smart terminal may display a seventh message on the control user interface, the seventh message indicating that a return instruction cannot be received. The smart terminal may acquire an identification of an aircraft that has already taken off. The smart terminal may display an eighth message on the control user interface, the eighth message indicating that the control user interface is standing by to receive the return instruction. When the control user interface receives the return instruction, the smart terminal may send the return instruction to the aircraft identified by the identification. In some embodiments, when at least one aircraft has not taken off, the smart terminal may disable the descend and return button by changing the display of the style and/or color of the button (e.g., by displaying the descend and return button in gray). Disabling the descend and return button may be an example of the seventh message. The smart terminal may remove the selection of an aircraft that has not taken off. The smart terminal may then enable the descend and return button (e.g., by changing the gray color to the normal color of descend and return button). Enabling the descend and return button may be an example of the eighth message. After the descend and return button is enabled, a user may control, e.g., through the control user interface of the smart terminal, at least one aircraft that has already taken off to return or to land.

Embodiments of the present disclosure also provide a computer readable medium configured to store computer program codes or instructions. The computer program codes may be executed by a processor to perform the disclosed methods, including the flight control methods of FIGS. 4 and 5.

According to various embodiments of the present disclosure, the smart terminal may send data of a flight route to multiple aircrafts to execute. The data of the flight route may include data of multiple flight routes obtained by dividing or splitting data of a main flight route. Alternatively or additionally, the data of the flight route may include data of multiple independent flight routes. Embodiments of the present disclosure allow for one-to-multiple control of multiple aircrafts using a single smart terminal, thereby enhancing efficiency of flight control. Embodiments of the present disclosure also satisfy user demands for automatic and intelligent control of multiple aircrafts. Moreover, embodiments of the present disclosure allow for intelligent detection of potential safety issues (e.g., the point of collision on different flight routes), thereby improving safety of one-to-multiple control of multiple aircrafts.

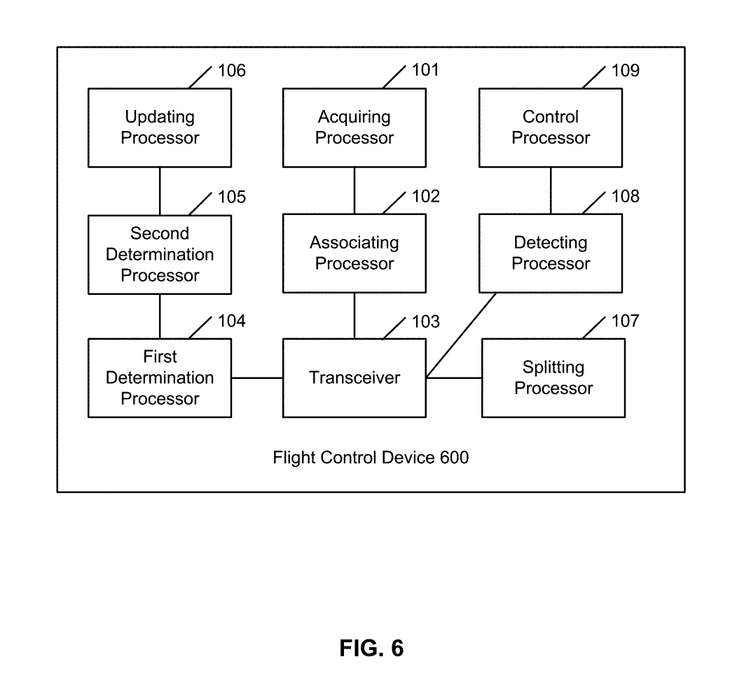

FIG. 6 is a schematic diagram of a flight control device 600 according to another example embodiment. The flight control device 600 may be included or implemented in any smart terminal disclosed herein. For example, the smart terminal disclosed herein may include any smart terminal that is equipped with wired or wireless communication capability, such as a personal computer (e.g., a laptop or desktop), a smart phone, a smart wearable device, etc. The flight control device 600 includes elements 101-109 shown in FIG. 6.

As shown in FIG. 6, The flight control device 600 includes an acquiring processor 101 configured or programmed to acquire, receive, or obtain data of at least two flight routes. The flight control device 600 includes an associating processor 102 configured or programmed to associate, link, or assign, based on information relating to at least two aircrafts, at least one aircraft with or to a flight route (e.g., each flight route) of the at least two flight routes. The flight control device 600 includes a transceiver 103 configured or programmed to send, based on a result of the associating, data of the flight route (e.g., each flight route) to at least one aircraft that is associated with the data of the flight route.

In some embodiments, the flight control device 600 may include a first determination processor 104 configured or programmed to determine location points on the flight route based on the data of the flight route, and to determine an estimated time of arrival for each of the location points. The flight control device 600 may include a second determination processor 105 configured or programmed to determine, based on the location points and the estimated time of arrival, whether there is a point of collision in the location points on the flight route. The flight control device 600 may include an updating processor 106 configured or programmed to trigger, when determining that there is a point of collision, an update to the flight route based on the point of collision.

In some embodiments, the first determination processor 104 may be configured or programmed to calculate, based on a preset velocity of the at least one aircraft and each of the location points, the estimated time of arrival for each of the at least one aircraft to arrive at each of the location points.

In some embodiments, the transceiver 103 may be configured to send data of at least two flight routes to a flight route broadcasting device to trigger the flight route broadcasting device to broadcast the data of the at least two flight routes to at least two aircrafts.

In some embodiments, the second determination processor 105 may be configured or programmed to determine a corresponding remote control device for an aircraft of the at least one aircraft, and to send data of the flight route associated with the aircraft of the at least one aircraft to the corresponding remote control device to enable the remote control device to control flight of the aircraft based on the data of the flight route received by the remote control device.

In some embodiments, the second determination processor 105 may be configured or programmed to send the data of the flight route to a flight control device provided in an aircraft of the at least one aircraft that is associated with the data of the flight route to enable the flight control device to control flight of the aircraft based on the data of flight route received by the flight control device.

In some embodiments, optionally, the flight control device 600 may include a splitting processor 107 configured or programmed to split or divide, when the data of the at least two flight routes include data of a flight route that satisfy predetermined criteria for splitting or division, the data of the flight route into data for multiple sub-routes. The transceiver 103 may send data for each of the multiple sub-routes to at least one aircraft. In some embodiments, the data of the flight route that satisfy the predetermined criteria for splitting or division include data indicating that a length of the flight route is greater than a predetermined length, or data indicating that a number of the location points on the flight route is greater than a predetermined number.

In some embodiments, the transceiver 103 of the flight control device 600 may be configured to send, when receiving an execution instruction through a control user interface, the execution instruction to the associated at least one aircraft that received the data of the flight route, the execution instruction triggering the associated at least one aircraft to execute the data of the flight route. The flight control device 600 may include a detecting processor 108 configured to detect status of execution of the data of the flight route for each of the at least one aircraft. The flight control device 600 may include a control processor 109 configured or programmed to control the control user interface based on the status of execution of the data of the flight route.

In some embodiments, the control processor 109 may determine, based on the status of execution of the data of the flight route, that an aircraft has not executed the data of the flight route, and may display a first message on the control user interface, the first message indicating that the execution instruction cannot be received. The control processor 109 may acquire an identification of the aircraft that has not executed the data of the flight route. The control processor 109 may display a second message on the control user interface, the second message indicating that the control user interface is standing by to receive the execution instruction. When receiving the execution instruction through the control user interface after displaying the second message, the control processor 109 may instruct the transceiver 103 to send the execution instruction to the aircraft identified by the identification that has not executed the data of the flight route.

In some embodiments, the control processor 109 may determine, based on the status of execution of the data of the flight route, that an aircraft has not executed the data of the flight route, and may display a third message on the control user interface, the third message indicating that a flight control instruction cannot be received. The control processor 109 may acquire an identification of an aircraft that has already executed the data of the flight route. The control processor 109 may display on the control user interface, a fourth message, the fourth message indicating that the control user interface is standing by to receive the flight control instruction. When the control user interface receives the flight control instruction, the control processor 109 may instruct the transceiver 103 to send the flight control instruction to the aircraft identified by the identification that has already executed the data of the flight route.

In some embodiments, the control processor 109 may determine, based on the status of execution of the data of the flight route, that an aircraft has not taken off, and may display a fifth message on the control user interface, the fifth message indicating that a take-off instruction cannot be received. The control processor 109 may acquire an identification of the aircraft that has not taken off. The control processor 109 may display a sixth message on the control user interface, the sixth message indicating that the control user interface is standing by to receive the take-off instruction. When the control user interface receives the take-off instruction, the control processor 109 may instruct the transceiver 103 to send the take-off instruction to the aircraft identified by the identification that has not taken off.

In some embodiments, the control processor 109 may determine, based on the status of execution of the data of the flight route, that an aircraft has not taken off, and may display a seventh message on the control user interface, the seventh message indicating that a return instruction cannot be received. The control processor 109 may acquire an identification of an aircraft that has already taken off. The control processor 109 may display an eighth message on the control user interface, the eighth message indicating that the control user interface is standing by to receive the return instruction. When the control user interface receives the return instruction, the control processor 109 may instruct the transceiver 103 to send the return instruction to the aircraft identified by the identification.

Detailed implementations of the processors and transceiver included in the embodiment shown in FIG. 6 can refer to the above descriptions regarding the functions, methods, and processes.

According to various embodiments of the present disclosure, the smart terminal may send data of a flight route to multiple aircrafts to execute. The data of the flight route may include data of multiple flight routes obtained by dividing data of a main flight route. Alternatively or additionally, the data of the flight route may include data of multiple independent flight routes. Embodiments of the present disclosure allow for one-to-multiple control of multiple aircrafts using a single smart terminal, thereby enhancing efficiency of flight control. Embodiments of the present disclosure also satisfy user demands for automatic and intelligent control of multiple aircrafts. Moreover, embodiments of the present disclosure allow for intelligent detection of potential safety issues (e.g., the point of collision on different flight routes), thereby improving safety of one-to-multiple control of multiple aircrafts.

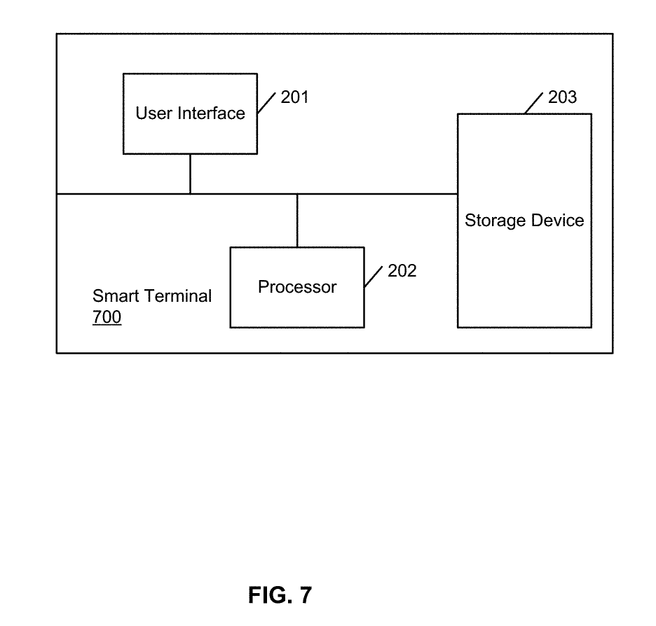

FIG. 7 is a schematic diagram of a smart terminal 700 according to another example embodiment. The smart terminal 700 may be a smart phone, a tablet, a personal computer (e.g., a laptop, a desktop), etc. The smart terminal 700 may include a power supply, a communication interface or port, a physical keyboard, a housing, etc. The smart terminal 700 may also include a user interface 201 (e.g., the control user interface disclosed herein), a processor 202, and a storage device 203.

The user interface 201 may include a touch screen configured to process input or data relating to human-machine interactions. For example, the user interface 201 may display an interaction interface for interacting with a user, receiving user input of data, and displaying messages to the user. The storage device 202 may include a volatile memory, a non-volatile memory, or a combination of a volatile memory and a non-volatile memory. The processor 202 may be a central processing unit (CPU). The processor 202 may include hardware chips. The hardware chips may be an application-specific integrated circuit (ASIC), a programmable logic device (PLD), or a combination thereof. The PLD may be complex programmable logic device (CPLD), a field-programmable gate array (FPGA), a generic array logic (GAL), or any combination thereof.

In some embodiments, the storage device 203 may be configured to store computer program instructions or codes. The processor 202 may retrieve the computer program instructions or codes from the storage device 203, and execute the computer program instructions or codes to perform the flight control methods illustrated in FIGS. 4-5.

For example, the processor 202 may execute the computer program instructions to acquire data of at least two flight routes. The processor 202 may associate, based on preset information of at least two aircrafts, at least one aircraft with a flight route (e.g., each flight route) of the at least two flight routes. The processor 202 may send, based on a result of the associating, data of the flight route (e.g., each flight route) to the associated at least one aircraft.

In some embodiments, the processor 202 may execute the computer program instructions to determine location points on the flight route based on the data of the flight route and may determine an estimated time of arrival for each of the location points. The processor 202 may determine, based on the location points and the estimated time of arrival, whether there is a point of collision in the location points on the flight route. When determining that there is a point of collision, the processor 202 may trigger an update to the flight route based on the point of collision.

In some embodiments, when the processor 202 execute the computer program instructions to determine the estimated time of arrival for each of the location points, the processor 202 may calculate, based on a preset velocity of the at least one aircraft and each of the location points, the estimated time of arrival for each of the at least one aircraft to arrive at each of the location points.

In some embodiments, when the processor 202 executes the computer program instructions to send data of the flight route (e.g., each flight route) to the associated at least one aircraft, the processor 202 may send data of at least two flight routes to a flight route broadcasting device to trigger the flight route broadcasting device to broadcast the data of the at least two flight routes to at least two aircrafts.

In some embodiments, when the processor 202 executes the computer program instructions to send data of the flight route (e.g., each flight route) to the associated at least one aircraft, the processor 202 may determine a corresponding remote control device for an aircraft of the at least one aircraft. The processor 202 may send data of the flight route associated with the aircraft of the at least one aircraft to the corresponding remote control device to enable the remote control device to control flight of the aircraft based on the data of the flight route received by the remote control device.

In some embodiments, when the processor 202 executes the computer program instructions to send data of the flight route (e.g., each flight route) to the associated at least one aircraft, the processor 202 may send the data of the flight route to a flight control device provided in an aircraft of the at least one aircraft that is associated with the data of the flight route to enable the flight control device to control flight of the aircraft based on the data of flight route received by the flight control device.

In some embodiments, the processor 202 may execute the computer program instructions to split, when the data of the at least two flight routes include data of a flight route that satisfy predetermined criteria for splitting, the data of the flight route into data for multiple sub-routes. The processor 202 may send data for each of the multiple sub-routes to at least one aircraft.

In some embodiments, the data of the flight route that satisfy the predetermined criteria for splitting include data indicating that a length of the flight route is greater than a predetermined length. In some embodiments, the data of the flight route that satisfy the predetermined criteria for splitting include data indicating that a number of the location points on the flight route is greater than a predetermined number.

In some embodiments, the processor 202 may execute the computer program instructions to send, when receiving an execution instruction through a control user interface, the execution instruction to the associated at least one aircraft that received the data of the flight route, the execution instruction triggering the associated at least one aircraft to execute the data of the flight route. The processor 202 may detect status of execution of the data of the flight route for each of the at least one aircraft. The processor 20 may control, based on the status of execution of the data of the flight route, the control user interface.

In some embodiments, when the processor 202 executes the computer program instructions to control the control user interface based on the status of execution of the data of the flight route, the processor 202 determine, based on the status of execution of the data of the flight route, that an aircraft has not executed the data of the flight route. The processor 202 may display a first message on the control user interface, the first message indicating that the execution instruction cannot be received. The processor 202 may acquire an identification of the aircraft that has not executed the data of the flight route. The processor 202 may display a second message on the control user interface, the second message indicating that the control user interface is standing by to receive the execution instruction. The processor 202 may send, when receiving the execution instruction through the control user interface after displaying the second message, the execution instruction to the aircraft identified by the identification that has not executed the data of the flight route.

In some embodiments, when the processor 202 executes the computer program instructions to control the control user interface based on the status of execution of the data of the flight route, the processor 202 may determine, based on the status of execution of the data of the flight route, that an aircraft has not executed the data of the flight route. The processor 202 may display a third message on the control user interface, the third message indicating that a flight control instruction cannot be received. The processor 202 may acquire an identification of an aircraft that has already executed the data of the flight route. The processor 202 may display, on the control user interface, a fourth message, the fourth message indicating that the control user interface is standing by to receive the flight control instruction. When the control user interface receives the flight control instruction, the processor 202 may send the flight control instruction to the aircraft identified by the identification that has already executed the data of the flight route.

In some embodiments, when the processor 202 executes the computer program instructions to control the control user interface based on the status of execution of the data of the flight route, the processor 202 may determine, based on the status of execution of the data of the flight route, that an aircraft has not taken off. The processor 202 may display a fifth message on the control user interface, the fifth message indicating that a take-off instruction cannot be received. The processor 202 may acquire an identification of the aircraft that has not taken off. The processor 202 may display a sixth message on the control user interface, the sixth message indicating that the control user interface is standing by to receive the take-off instruction. When the control user interface receives the take-off instruction, the processor 202 may send the take-off instruction to the aircraft identified by the identification that has not taken off.

In some embodiments, when the processor 202 executes the computer program instructions to control the control user interface based on the status of execution of the data of the flight route, the processor 202 may determine, based on the status of execution of the data of the flight route, that an aircraft has not taken off. The processor 202 may display a seventh message on the control user interface, the seventh message indicating that a return instruction cannot be received. The processor 202 may acquire an identification of an aircraft that has already taken off. The processor 202 may display an eighth message on the control user interface, the eighth message indicating that the control user interface is standing by to receive the return instruction. When the control user interface receives the return instruction, the processor 202 may send the return instruction to the aircraft identified by the identification.

The detailed implementation of the smart terminals disclosed herein in accordance with various embodiments of the present disclosure can refer to the above descriptions of the functions, methods, and processes.

According to various embodiments of the present disclosure, the smart terminal may send data of a flight route to multiple aircrafts to execute. The data of the flight route may include data of multiple flight routes obtained by dividing or splitting data of a main flight route. Alternatively or additionally, the data of the flight route may include data of multiple independent flight routes. Embodiments of the present disclosure allow for one-to-multiple control of multiple aircrafts using a single smart terminal, thereby enhancing efficiency of flight control. Embodiments of the present disclosure also satisfy user demands for automatic and intelligent control of multiple aircrafts. Moreover, embodiments of the present disclosure allow for intelligent detection of potential safety issues (e.g., the point of collision on different flight routes), thereby improving safety of one-to-multiple control of multiple aircrafts.

A person having ordinary skill in the art can appreciate that part or all of the above disclosed methods and processes may be implemented using related hardware that may be controlled or instructed by computer program instructions. The computer program instructions may be stored in a non-transitory computer-readable storage medium. When the computer program instructions are executed by a processor or controller, method performed by the processor or controller may include the above disclosed methods or processes. The non-transitory computer-readable storage medium can be any medium that can store program codes, for example, a magnetic disk, an optical disk, a read-only memory (ROM), or a random access memory (RAM), etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A flight control method, comprising:
acquiring, by a smart terminal, data of at least two flight routes;
associating, by the smart terminal and based on preset information of at least two aircrafts, at least one aircraft with a flight route of the at least two flight routes; and
based on a result of the associating, sending, by the smart terminal, data of the flight route to the associated at least one aircraft.

2. The flight control method of claim 1, further comprising:
determining location points on the flight route based on the data of the flight route;
determining an estimated time of arrival for each of the location points;
based on the location points and the estimated time of arrival, determining whether there is a point of collision in the location points on the flight route; and
when determining that there is a point of collision, triggering an update to the flight route based on the point of collision.

3. The flight control method of claim 2, wherein determining the estimated time of arrival for each of the location points comprises:
based on a preset velocity of the at least one aircraft and each of the location points, calculating the estimated time of arrival for each of the at least one aircraft to arrive at each of the location points.

4. The flight control method of claim 1, wherein sending, by the smart terminal, data of the flight route to the associated at least one aircraft comprises:
sending, by the smart terminal, data of at least two flight routes to a flight route broadcasting device to trigger the flight route broadcasting device to broadcast the data of the at least two flight routes to at least two aircrafts; and/or
sending, by the smart terminal, the data of the flight route to a flight control device provided in an aircraft of the at least one aircraft that is associated with the data of the flight route to enable the flight control device to control flight of the aircraft based on the data of flight route received by the flight control device.

5. The flight control method of claim 1, wherein sending, by the smart terminal, data of the flight route to the associated at least one aircraft comprises:
determining, by the smart terminal, a corresponding remote control device for an aircraft of the at least one aircraft; and
sending, by the smart terminal, data of the flight route associated with the aircraft of the at least one aircraft to the corresponding remote control device to enable the remote control device to control flight of the aircraft based on the data of the flight route received by the remote control device.

6. The flight control method of claim 1, further comprising:
when the data of the at least two flight routes include data of a flight route that satisfy predetermined criteria for splitting, splitting the data of the flight route into data for multiple sub-routes, and sending data for each of the multiple sub-routes to at least one aircraft,
wherein the data of the flight route that satisfy the predetermined criteria for splitting comprise data indicating that a length of the flight route is greater than a predetermined length, or data indicating that a number of the location points on the flight route is greater than a predetermined number.

7. The flight control method of claim 1, further comprising:
when receiving an execution instruction through a control user interface, sending the execution instruction to the associated at least one aircraft that received the data of the flight route, the execution instruction triggering the associated at least one aircraft to execute the data of the flight route;
detecting status of execution of the data of the flight route for each of the at least one aircraft; and
based on the status of execution of the data of the flight route, controlling the control user interface.

8. The flight control method of claim 7, wherein based on the status of execution of the data of the flight route, controlling the control user interface comprises:
when determining, based on the status of execution of the data of the flight route, that an aircraft has not executed the data of the flight route, displaying a first message and/or a third message on the control user interface, the first message indicating that the execution instruction cannot be received and the third message indicating that a flight control instruction cannot be received;
acquiring an identification of the aircraft that has not executed the data of the flight route;
displaying a second message and/or a fourth message on the control user interface, the second message indicating that the control user interface is standing by to receive the execution instruction and the fourth message indicating that the control user interface is standing by to receive the flight control instruction; and
when receiving the execution instruction through the control user interface after displaying the second message, sending the execution instruction to the aircraft identified by the identification that has not executed the data of the flight route.

9. The flight control method of claim 7, wherein based on the status of execution of the data of the flight route, controlling the control user interface comprises:
when determining, based on the status of execution of the data of the flight route, that an aircraft has not taken off, displaying a fifth message on the control user interface, the fifth message indicating that a take-off instruction cannot be received;
acquiring an identification of the aircraft that has not taken off; displaying a sixth message on the control user interface, the sixth message indicating that the control user interface is standing by to receive the take-off instruction; and when the control user interface receives the take-off instruction, sending the take-off instruction to the aircraft identified by the identification that has not taken off; and/or
when determining, based on the status of execution of the data of the flight route, that an aircraft has not taken off, displaying a seventh message on the control user interface, the seventh message indicating that a return instruction cannot be received;
acquiring an identification of an aircraft that has already taken off; displaying an eighth message on the control user interface, the eighth message indicating that the control user interface is standing by to receive the return instruction; and when the control user interface receives the return instruction, sending the return instruction to the aircraft identified by the identification.

10. A smart terminal, comprising:
a user interface; and
a processor,
wherein the user interface is configured to process data relating to human-machine interaction, and
wherein the processor is configured to:
acquire data of at least two flight routes;
based on preset information of at least two aircrafts, associate at least one aircraft with a flight route of the at least two flight routes; and
based on a result of the associating, send data of the flight route to the associated at least one aircraft.

11. The smart terminal of claim 10, wherein the processor is further configured to:
determine location points on the flight route based on the data of the flight route;
determine an estimated time of arrival for each of the location points;
based on the location points and the estimated time of arrival, determine whether there is a point of collision in the location points on the flight route; and
when determining that there is a point of collision, trigger an update to the flight route based on the point of collision.

12. The smart terminal of claim 11, wherein when the processor determines the estimated time of arrival for each of the location points, the processor is further configured to:
based on a preset velocity of the at least one aircraft, calculate the estimated time of arrival for each of the at least one aircraft to arrive at each of the location points.

13. The smart terminal of claim 12, when the processor sends the data of the flight route to the associated at least one aircraft, the processor is further configured to:
send data of at least two flight routes to a flight route broadcasting device to trigger the flight route broadcasting device to broadcast the data of the at least two flight routes to at least two aircrafts; and/or
send the data of the flight route to a flight control device provided in an aircraft of the at least one aircraft that is associated with the data of the flight route to enable the flight control device to control flight of the aircraft based on the data of flight route received by the flight control device.

14. The smart terminal of claim 10, when the processor sends the data of the flight route to the associated at least one aircraft, the processor is further configured to:
determine a corresponding remote control device for an aircraft of the at least one aircraft; and
send data of the flight route associated with the aircraft of the at least one aircraft to the corresponding remote control device to enable the remote control device to control flight of the aircraft based on the data of the flight route received by the remote control device.

15. The smart terminal of claim 10, when the processor is further configured to:
when the data of the at least two flight routes include data of a flight route that satisfy predetermined criteria for splitting, split the data of the flight route into data for multiple sub-routes, and send data for each of the multiple sub-routes to at least one aircraft,
wherein the data of the flight route that satisfy the predetermined criteria for splitting comprise data indicating that a length of the flight route is greater than a predetermined length, or data indicating that a number of the location points on the flight route is greater than a predetermined number.

16. The smart terminal of claim 10, when the processor is further configured to:
when receiving an execution instruction through a control user interface, send the execution instruction to the associated at least one aircraft that received the data of the flight route, the execution instruction triggering the associated at least one aircraft to execute the data of the flight route; and
detect status of execution of the data of the flight route for each of the at least one aircraft; and
based on the status of execution of the data of the flight route, control the control user interface.

17. The smart terminal of claim 16, when the processor controls the control user interface based on the status of execution of the data of the flight route, the processor is further configured to:
when determining, based on the status of execution of the data of the flight route, that an aircraft has not executed the data of the flight route, display a first message on the control user interface, the first message indicating that the execution instruction cannot be received;
acquire an identification of the aircraft that has not executed the data of the flight route;
display a second message on the control user interface, the second message indicating that the control user interface is standing by to receive the execution instruction; and
when receiving the execution instruction through the control user interface after displaying the second message, send the execution instruction to the aircraft identified by the identification that has not executed the data of the flight route.

18. The smart terminal of claim 16, when the processor controls the control user interface based on the status of execution of the data of the flight route, the processor is further configured to:
when determining, based on the status of execution of the data of the flight route, that a first aircraft has not executed the data of the flight route, display a third message on the control user interface, the third message indicating that a flight control instruction cannot be received;
acquire an identification of an aircraft that has already executed the data of the flight route;
display, on the control user interface, a fourth message, the fourth message indicating that the control user interface is standing by to receive the flight control instruction; and
when the control user interface receives the flight control instruction, send the flight control instruction to the aircraft identified by the identification that has already executed the data of the flight route.

19. The smart terminal of claim 16, when the processor controls the control user interface based on the status of execution of the data of the flight route, the processor is further configured to:
when determining, based on the status of execution of the data of the flight route, that an aircraft has not taken off, display a fifth message on the control user interface, the fifth message indicating that a take-off instruction cannot be received;
acquire an identification of the aircraft that has not taken off;
display a sixth message on the control user interface, the sixth message indicating that the control user interface is standing by to receive the take-off instruction; and
when the control user interface receives the take-off instruction, send the take-off instruction to the aircraft identified by the identification that has not taken off.

20. The smart terminal of claim 16, when the processor controls the control user interface based on the status of execution of the data of the flight route, the processor is further configured to:
when determining, based on the status of execution of the data of the flight route, that an aircraft has not taken off, display a seventh message on the control user interface, the seventh message indicating that a return instruction cannot be received;
acquire an identification of an aircraft that has already taken off;
display an eighth message on the control user interface, the eighth message indicating that the control user interface is standing by to receive the return instruction; and
when the control user interface receives the return instruction, send the return instruction to the aircraft identified by the identification.
